(19) United States
(12) Patent Application Publication
(10) Pub. No.: US 2010/0020938 A1
(43) Pub. Date: Jan. 28, 2010

(54) DEVICE AND METHOD FOR X-RAY TUBE FOCAL SPOT SIZE AND POSITION CONTROL

(75) Inventors: Lothar Koch, Hamburg (DE); Wolfgang Chrost, Hamburg (DE); Horst Roloff, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/518,289

(22) PCT Filed: Dec. 7, 2007
(86) PCT No.: PCT/IB07/54959

§ 371 Date: Jun. 9, 2009

(30) Foreign Application Priority Data
Dec. 12, 2006 (EP) 06125905.7

(51) Int. Cl. H01J 35/14

(52) U.S. Cl. 378/138

(57) ABSTRACT

A device and method for X-ray tube focal spot parameter control, wherein stray electrons are detected in an X-ray tube. The detected electrons lead to a signal having a characteristic pattern. The characteristic pattern may be evaluated, and based on the evaluation a controlling signal may be outputted so that a fast and exact controlling of the operating parameters of an X-ray tube may be carried out based on the detected stray electrons.

The present invention relates to a device and method for X-ray tube focal spot parameter control, and in particular to a focal spot size and position control based on the detection of strayed electrons, such that the state and condition of the focal spot can be determined and a fast controlling thereof can be carried out to improve the efficiency of an x-ray tube operation.

### BACKGROUND OF THE INVENTION

In an X-ray tube, about 40% of the electrons hitting the anode are reflected (strayed). The amount of these stray electrons hitting any given region inside the X-ray tube can vary considerably. The reason may be, for example, a deviation of focal spot parameters from the optimum focal spot parameters, wherein the focal spot parameters may be the focal spot size or the focal spot position. In many applications of x-ray examination apparatuses, only very small tolerances for variations of focal spot parameters, e.g. focal spot size and focal spot positions, can be tolerated during an examination procedure for instance of a computer tomography (CT) scan, without compromising the imaging quality. Maintaining the required tolerances is difficult to realise because during a CT scan many parts of an X-ray tube heat up considerably, leading to changes of mechanical and electrical properties, which influence for example the focal spot size and position.

U.S. 2004/0190682 A1 describes a method and device for setting the focal spot position of an X-ray tube by a closed loop regulation circuit. A deflector deflects the electron beam of the X-ray tube depending on a deflection signal, a deflection closed loop regulator generates the deflection signal depending on a focal spot position signal. A measurement arrangement measures a focal spot position signal. The deflector, the deflection closed loop regulator and the measurement arrangement form a closed loop regulation circuit with a focal spot position as the controlled variable and with the deflection signal as the control parameter. For this purpose, U.S. 2004/0190682 A1 describes two photo detectors for the measurement of the position of the X-ray beam, wherein the photo detectors are provided outside the tube. The photo detectors provide a low or no output signal, if the X-ray beam is displaced in one or the other direction away from the optical path provided for it, then the output signal of one of the two focal detectors will be larger and that of the other will be smaller or remains zero. As an alternative, instead of the photo detectors, infrared cameras are provided, arranged in such a manner that they measure the temperature of the anode at different positions.

There is, however, no compensation for changes in the focal spot size, so that the control loop may react on wrong input signals. Another disadvantage of this approach is the need for costly equipment which must be designed to be mechanically stable under G-forces on a CT gantry and must be calibrated regularly to compensate differences in sensitivity and linearity of the two detectors building up over life time.

### SUMMARY OF THE INVENTION

It would be desirable to provide a method and device capable of an improved controlling of focal spot parameters.

The invention provides a device for providing a controlling signal for controlling focal spot parameters of a focal spot on an X-ray tube anode, a corresponding X-ray tube, an examination device for examining an object to be examined, a method for providing a control signal for controlling focal spot parameters of a focal spot on an X-ray tube anode, a corresponding program element and computer readable medium.

It should be noted that the following described exemplary embodiments of the invention apply also for the method and the device for providing a controlling signal, the corresponding examining device, the computer readable medium and the program element.

According to an exemplary embodiment of the present invention, a device for providing a controlling signal for controlling focal spot parameters of a focal spot on an X-ray tube anode comprises an interface adapted for receiving a signal having a characteristic pattern depending on stray electrons detected in the X-ray tube, an evaluation unit adapted for evaluating the characteristic pattern, and an output adapted for outputting a control signal based on the evaluation of the characteristic pattern. Stray electrons detected by a stray electron detection device lead to a stray electron current, wherein the current constitutes a signal having a characteristic pattern. The detection device may be located near the anode inside of an X-ray tube, e.g. close to the position of the focal spot. The characteristic of the pattern depends on the focal spot parameters so that it is possible to provide a controlling signal for controlling the operation parameters of an X-ray tube based on the evaluation of the characteristic pattern of the signal. The changes in the signal resulting from the changes of detected stray electrons may be detected in a high sequence. This allows to control the operation parameters of the x-ray tube in a very short cycle. The short cycle allows a fast control circuit to maintain optimum focal spot parameters. Thus, a more efficient operation of an X-ray tube is possible.

In other words, the present invention provides a simple and effective method for measuring focal spot parameters like the focal spot size and the focal spot position, wherein it is possible to correct deviations of the focal spot parameters. The present invention further allows time constants less than about one millisecond to avoid artefacts in modern CT systems with gantry rotation times below 0.5 seconds.

According a further exemplary embodiment of the present invention, the controlling signal is adapted to control the focal spot parameters by controlling operating parameters of the X-ray tube. The controlling signal can be used to control operating parameters of the X-ray tube like the voltage and current for the X-ray tube. Further, the signal can be used to control an active electron beam focusing and deflection device, for example, electromagnetic lenses.

According to a further exemplary embodiment of the present invention, the device further comprises a look-up table having stored therein at least one relation between the characteristic patterns and the corresponding operating parameters and/or the corresponding focal spot parameters. By using a look-up table, in combination with for example a pattern decoder, the actual focal spot parameters like the focal spot size and the focal spot position can be determined and may be compared with a nominal or desired position. This allows to calculate a correction. Electromagnetic electron beam deflection and shaping lenses can then be used to correct any deviations.

According to a further exemplary embodiment of the present invention, the focal spot parameters are a focal spot size and/or a focal spot position. The focal spot size and the focal spot position are parameters allowing to describe important properties of the focal spot.

According to an exemplary embodiment of the present invention, the operating parameters of the X-ray tube are parameters for influencing electron beam focusing and/or deflection. By means of focusing the electron beam and its deflection, the size of the focal spot and its position on the surface of the electrode may be influenced so that controlling electron beam focusing and deflection are appropriate possibilities to control the focal spot parameters.

According to an exemplary embodiment of the present invention, the device comprises a filter and/or pulse shaper adapted for separating focal spot parameter information included in the received signal. The filter may be a band pass filter, a high pass filter or a low pass filter depending on the composition of the signal and the information included therein. In case the signal includes information relating to two or more parameters the information must be distinguished for the further processing. In particular, when the signal is modulated by means of any modification of the anode surface, it is useful to provide a band pass filter and a pulse shaper, since the resulting modulation pattern will be characteristic for a certain combination of parameters leading to the signal. The signal may be based on a current resulting from the detected electrons, wherein the current may be a function of the X-ray tube voltage, the X-ray tube current and geometrical factors alpha (α), beta (β) and gamma (γ). Alpha depends on the size of an electron detection device and its position relative to the anode disk, beta depends on the size of the focal spot, and gamma depends on the position of the focal spot on the anode disk. In order to use the current as an input for a control loop to control the focal spot parameters like the size and position of the focal spot, additional information can be used to determine and to describe the current completely. This additional information may be obtained by modulation of the stray electrons, as will be described below.

According to an exemplary embodiment of the present invention, the device comprises a controlling unit adapted to generate the controlling signal for controlling the focal spot parameters based on information stored in the look-up table and on desired focal spot parameters. Thus, it is possible to input desired focal spot parameters and to control the operation parameters of the X-ray tube by means of a controlling loop. It should be noted that for a constant focal spot size and a constant focal spot position, the current can be measured and used, for example, via a calibration table.

According to an exemplary embodiment of the present invention, an X-ray tube comprises an emitter for emitting electrons, an anode for receiving emitted electrons and a detection unit, adapted to detect stray electrons reflected from the anode, and adapted to output a signal depending on the detected stray electrons. Providing an X-ray tube with a detection unit for detecting stray electrons allows to detect stray electrons inside the X-ray tube without larger disturbances. The current depends on the tube voltage and current, and on the focal spot size and location on the anode. Using a calibration table for the tube voltage and current, and additional information on either the focal spot size or position, the stray electron current can be used to calculate the focal spot position or size, respectively. Changes in the stray electron current may be detected with a high frequency so that time constants should be less than about one millisecond, which allows to avoid artefacts in modern CT systems with a high speed gantry rotation faster than two rotations per second.

According to an exemplary embodiment of the present invention, the detection unit is adapted to output the signal having a characteristic pattern, wherein the characteristic depends on the detected stray electrons. Particular changes in the focal spot parameters like size and position lead to a change of the stray electrons and thus to a modified current. This leads to a signal including information which can be used to obtain the focal spot parameters from the characteristic of the signal and the corresponding current, respectively.

According to an exemplary embodiment of the present invention, the detection unit comprises a collector for collecting the stray electrons, wherein the collector, according to a further exemplary embodiment of the present invention, is electrically isolated from the X-ray tube. This allows to provide an external current or voltage to the collector to increase the capability of measuring the detected and collected electrons reflected from the anode. An electron collector collects electrons straight from the anode disk of an X-ray tube during the operation. The electron collector, when electrically isolated from the tube frame, can for example be put on a small positive potential relative to the anode disk by means of an outer electrical circuit. Thus, stray electrons can be detected as a current flowing through this circuit. This current is a function of the X-ray tube voltage and current as well as geometrical factors alpha, beta and gamma, as described above.

According to a further exemplary embodiment of the present invention, the surface of the anode is provided with one or more marks capable of modulating the number of stray electrons detected by the detecting unit. According to a further exemplary embodiment, the marks are grooves and/or pimples. Pimples may be protrusions or recesses on the surface of the anode. The marks on the surface of the anode will modulate the number of electrons reaching the stray electron collector and thus the current and signal, when the focal spot passes such a mark. Providing a pattern of marks on the surface of the electrode therefore leads to a corresponding pattern of the strayed electrons. Providing the pattern of marks beside the desired track of the focal spot the corresponding pattern in the signal only occurs when the focal spot deviates from the desired track. Thus, occurrence of the pattern in the signal may provide a measure of the deviation degree of the focal spot position from the desired track. The same may be applied for the focal spot size and any other focal spot parameter, where it is appropriate. The modulation will have a frequency which is a multiple of the anode disk rotary frequency, depending on the number of such marks along the circumference of the anode disk. Either the focal spot size or the focal spot position or both can be detected using the modulation information.

Using the modulation information and the calibration table in addition may enhance the accuracy of the measurement. Further, in case of tubes using different focal spot positions during one X-ray pulse, either discontinuously, known as, for example, ‘dynamic focal spot’, or continuously, the additional information is necessary to separate the effects. For the separation of those effects, filters and pulse shapers may be used, as described above.

According to an exemplary embodiment of the present invention, an examination device for examining an object to be examined comprises a device according to any of the above embodiments of the device for providing a controlling signal for controlling focal spot parameters of a focal spot on an X-ray tube anode, and an X-ray tube according to any of the above embodiments of an X-ray tube.

According to a further exemplary embodiment of the present invention, a method is provided corresponding to the above devices.

The method according to an exemplary embodiment of the present invention comprises detecting stray electrons reflected from the anode, outputting a signal having a characteristic pattern, wherein the signal is based on the detected stray electrons, evaluating the characteristic pattern, and generating the controlling signal for controlling focal spot parameters by controlling operating parameters of the X-ray tube, wherein the signal is based on the evaluation of the characteristic pattern.

According to an exemplary embodiment of the present invention, the method comprises comparing the characteristic pattern with information stored in a look-up table having stored therein at least one relation between the characteristic patterns and the corresponding operating parameters and/or the corresponding focal spot parameters. The look-up table allows a fast evaluation by comparing the characteristic patterns with corresponding operating parameters and/or corresponding focal spot parameters. Thus, a detected pattern can be allocated to the operating parameters and focal spot parameters resulting in the characteristic of the pattern. It should be noted that the characteristic of a pattern may be any parameter, e.g. frequency, frequency pattern, height, etc., of a signal capable of carrying information. The characteristic pattern is not limited to impulses or frequencies, but may also be understood as the, for example, DC amount of a current. When periodic grooves or pimples are provided on the surface of an electrode for modifying the stray electron current, the signal contains a periodic returning parameter included in the characteristic pattern.

According to an exemplary embodiment the method further comprises comparing the characteristic pattern with information stored in a look-up table having stored therein at least one relation between the characteristic patterns and the corresponding operating parameters and/or the corresponding focal spot parameters.

According to an exemplary embodiment of the present invention, the generating is based on information stored in the look-up table. Thus, the generation of a controlling signal can be carried out very quickly when the detected pattern corresponds to a pattern stored in the look-up table and then can be allocated to corresponding operating parameters and/or corresponding focal spot parameters. The look-up table may also be replaced by an algorithm expressing the relation of the characteristic patterns with corresponding operating parameters and/or corresponding focal spot parameters, where it is appropriate.

According to a further exemplary embodiment of the present invention, the operating parameters of the X-ray tube comprise parameters for influencing electron beam focusing and/or deflection. Since the focal spot results from electrons emitted by an emitter, wherein the emitted electrons hit the anode, the electron beam can be influenced by focusing and/or deflection, for example, by electromagnetic lenses. It should be noted that not all electrons emitted by the emitter may hit the anode, or at least the intended array of the anode, so that electrons also means a part of electrons emitted by the emitter.

According to an exemplary embodiment of the present invention, detecting stray electrons also comprises collecting stray electrons. Collecting means that the collected electrons directly result in the current constituting the signal. It should be noted, that also the amount of charges due to the collected electrons may serve as a measure for evaluating. As an alternative, stray electrons can be detected by a detecting device, for example, in form of a multiplier, so that the signal results from an amplified electron current.

According to an exemplary embodiment of the present invention, a voltage is provided to a collector which is electrically isolated from the X-ray tube, for example, a small positive potential relative to the anode disk, so that the stray electrons can be detected as a current flowing through this circuit. In this case the potential converts the collected charges into a current.

According to an exemplary embodiment of the present invention, generating controlling signals for controlling the focal spot parameters is based on information stored in the look-up table and on desired focal spot parameters. This allows to provide a control loop, which is capable of providing a controlling signal based on predetermined focal spot parameters inputted or predetermined by a user. The look-up table may be replaced by an algorithm, as described above.

According to an exemplary embodiment of the present invention, the number of stray electrons may be modulated by providing marks on the surface of the anode. The effect thereof corresponds to the above described embodiment of the method.

According to an exemplary embodiment of the present invention, a programme element is provided which, when being executed by a processor, is adapted to carry out one of the above embodiments of the method.

According to an exemplary embodiment of the present invention, a computer readable medium having stored the above program element.

It may be seen as the gist of the present invention to use detected stray electrons detected within an X-ray tube for a fast controlling of operating parameters for an X-ray tube, wherein the principle of detecting strayed electrons in a fast sequence allows an exact and fast controlling.

These and other aspects of the present invention will become apparent from and elucidated with reference to the embodiments described hereinafter.

### BRIEF DESCRIPTION OF THE DRAWINGS

Exemplary embodiments of the present invention will be described in the following with reference to the following drawings.

FIG. 1 shows a device for providing a controlling signal for controlling focal spot parameters of a focal spot on an X-ray tube anode.

FIG. 2 illustrates an X-ray tube having an emitter for emitting electrons, an anode which is rotably mounted in order to spread the impact on the surface of the anode.

FIG. 3 illustrates an enlarged view of the detection unit.

FIG. 4 illustrates the flow of the method according to an exemplary embodiment of the present invention.

### DETAILED DESCRIPTION OF THE EXEMPLARY EMBODIMENTS

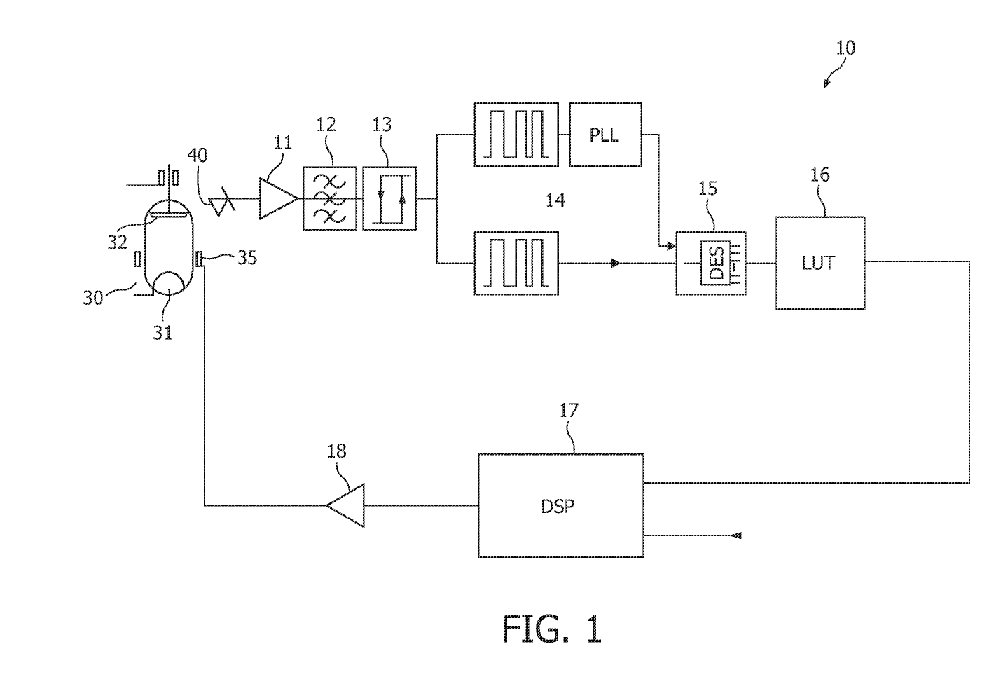

FIG. 1 shows a device for providing a controlling signal for controlling focal spot parameters of a focal spot on an X-ray tube anode 32. The device comprises an interface 11 serving for receiving a signal having a characteristic pattern depending on stray electrons detected in the X-ray tube 30. The X-ray tube is illustrated only for explanation purposes, and therefore schematically. The X-ray tube comprises an emitter 31 and an anode 32, wherein the emitter is adapted to emit electrons towards the anode. The detection unit 40 is illustrated outside the X-ray tube 30 for explanation purposes only, and can also be placed within the X-ray tube 30, in particular when detecting stray electrons. The X-ray tube also comprises deflection coils 35. The interface 11 may be a terminal, however, can also be provided with an amplifier for the amplification of the received signal. The interface 11 may also include any processing utilities for processing of the received signal, where it is appropriate. The device 10 of FIG. 1 also includes a filter, which may be a band pass filter, a deep pass filter or a high pass filter, the selection thereof will be carried out by the person skilled in the art. A pulse shaper 13 may serve for shaping the pulses output by the filter 12. The device 10 may also be provided with a raster frequency unit 14 including a PLL tuning circuit. A pattern detector 15 is capable of decoding the characteristic pattern of the received signal so that the decoded pattern may be used for evaluating. The evaluating may be supported by using a look-up table 16. The look-up table may have stored at least one relation between the characteristic patterns and the corresponding operating parameters and/or the corresponding focal spot parameters. The focal spot parameters may be the focal spot position and the focal spot size.

The operating parameters may be the voltage and the current for controlling the electron emission and the deviation or the focusing of the electron beam within the X-ray tube 30. The output of the look-up table 16 is fed to controlling unit 17. The controlling unit 17 may be a digital position or size regulation. Further, it is possible to feed the control unit 17 by a nominal position/size value of a focal spot or by desired focal spot parameters in order to provide a control signal based on the information stored in the look-up table 16. The output 18 is adapted for outputting a controlling signal based on the evaluation of the characteristic pattern, wherein the generation of the controlling signal for controlling the focal spot parameters may be based on information stored in the look-up table 16 and on desired focal spot parameters additionally input to the controlling unit 17. The output may also include an amplifier or a post-processing unit, for example, for the amplification or pot-processing of a controlling signal, for instance for controlling the deflection by the deflecting coils 35.

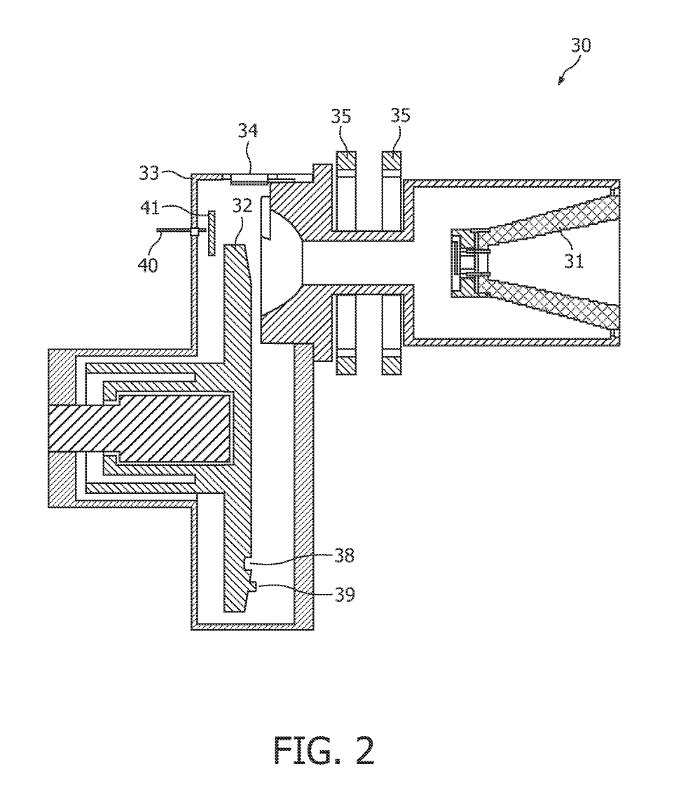

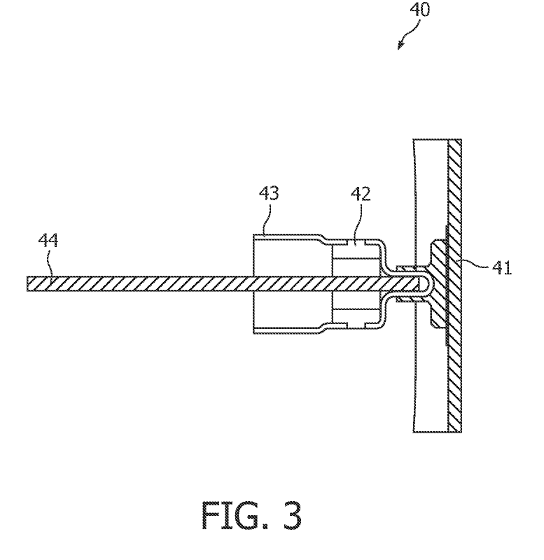

FIG. 2 illustrates an X-ray tube 30 having an emitter 31 for emitting electrons, an anode which is rotably mounted in order to spread the impact on the surface of the anode due to the electron beam emitted by the emitter. The anode 32 receives at least a part of the electrons emitted by the emitter 31. Deflecting coils 35 allow to focus and deflect the emitted electron beam from the emitter 31 in order to modify the focal spot with respect to position and size. The X-ray tube 30 is evacuated. A detection unit 40 is mounted to the frame 33 of the X-ray tube 30. The detection unit 40 comprises a collector 41 and will be described with respect to FIG. 3. The electrons emitted by the emitter 31 hit the surface of the anode 32 whereby X-radiation is generated, which exits the X-ray tube via the window 34.

The anode further comprises marks 38, 39 in form of grooves 38 and pimples 39. The marks 38, 39 in form of grooves 38 and pimples 39 are capable of modulating the number of electrons reaching the collector 41, when a focal spot passes such a mark 38, 39. The modulation will have a frequency which is a multiple of the anode disk rotation frequency, depending on the number of such marks 38, 39 along the circumference of the anode disk 32. Pimples may be recesses or protrusions on the surface of the anode in form of dots, short grooves, or any other appropriate design of protrusions or elevations. The pattern of the marks leads to a corresponding pattern in the signal. Providing marks beside the optimum path of the focal spot on the electrode leads to a corresponding pattern if the focal spot position leaves the optimum path so that the provision of different patterns depending on the distance to the edge of the optimum path allows to evaluate the deviation of the focal spot position.

By controlling the current and voltage supplied to the electromagnetic lenses in form of deviation coils 35 it is possible to modify the focal spot parameters, in particular the focal spot position on the surface of the anode 32 and the focal spot size. Depending on the focal spot size and the position the amount of stray electrons reflected from the surface of the anode 32 is higher or lower, so that the current is modified, and can be detected by the detection unit 40, in particular by the collector 41 of the detection unit 40.

FIG. 3 illustrates an enlarged view of the detection unit 40. The detection unit 40 comprises a collector 41. The detection unit 40 may comprise an insulator 42 for insulating the collector 41 from the frame 43 of the detection unit 40 and/or from the frame 33 of the X-ray tube 30. A lead 44 connects the collector for receiving the signal, which is generated by the received stray electrons.

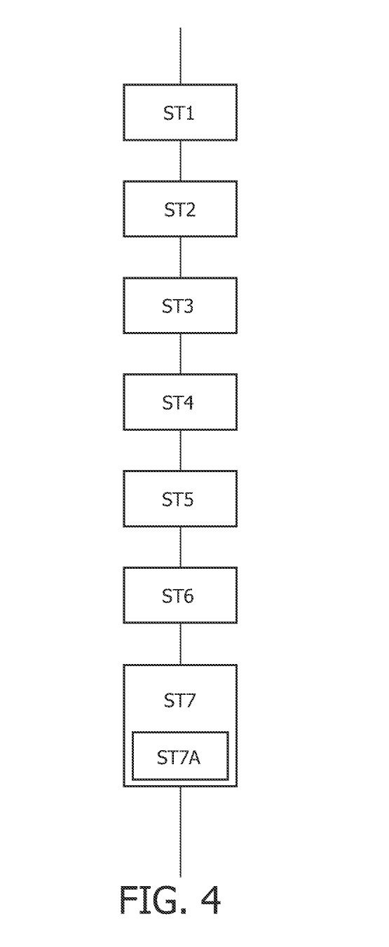

FIG. 4 illustrates the flow of the method according to an exemplary embodiment of the present invention. The method includes the detecting of stray electrons reflected from the anode ST2, outputting a signal having a characteristic pattern, wherein the signal is based on the detected stray electrons ST3 evaluating the characteristic pattern ST5 and generating the controlling signal for controlling focal spot parameters by controlling operating parameters of the X-ray tube, wherein the signal is based on the evaluation of the characteristic pattern ST7. Further, the method may comprise comparing the characteristic pattern with information stored in a look-up table 16 having stored therein at least one relation between the characteristic patterns and the corresponding operating parameters and/or the corresponding focal spot parameters ST6. The look-up table may be replaced by an appropriate algorithm. Further, the method may comprise filtering and/or pulse shaping of the received signal for providing separated focal spot parameter information ST4. The method may further comprise generating controlling signals for controlling the focal spot parameters based on information stored in the look-up table on desired focal spot parameters ST7A. Further, the method may comprise modulating the number of stray electrons ST1 by providing marks on the surface of the anode.

The details and the purpose of the several method elements and steps are explained with respect to the device in FIG. 1.

The application can be used for X-ray producing units (X-segments, especially in medical CT scanners and other diagnostic X-ray equipment).

It should be noted that the term ‘comprising’ does not exclude other elements or steps and the ‘a’ or ‘an’ does not exclude a plurality. Also elements described in association with different embodiments may be combined.

It should also be noted that reference signs in the claims shall not be construed as limiting the scope of the claims.

1. Device for providing a controlling signal for controlling focal spot parameters of a focal spot on an x-ray tube anode (2), the device (10) comprising:
an interface (11) adapted for receiving a signal having a characteristic pattern depending on stray electrons detected in the x-ray tube (30),
an evaluation unit (15, 16) adapted for evaluating the characteristic pattern, and
an output (18) adapted for outputting a controlling signal based on the evaluation of the characteristic pattern.

2. Device of claim 1, wherein the controlling signal is adapted to control the focal spot parameters by controlling operating parameters of the x-ray tube (30).

3. Device of claim 2, comprising a look-up table (16) having stored therein at least one relation between the characteristic patterns and the corresponding operating parameters and/or the corresponding focal spot parameters.

4. Device of claim 1, wherein the focal spot parameters are a focal spot size and/or a focal spot position.

5. Device of claim 1, wherein the operating parameters of the x-ray tube are parameters for influencing electron beam focussing and/or deflection.

6. Device of claim 1, comprising a filter (12) and/or pulse shaper (13) adapted for separating focal spot parameter information included in the received signal.

7. Device of claim 1, comprising a controlling unit adapted to generate the controlling signal for controlling the focal spot parameters based on information stored in the look-up table and on desired focal spot parameters.

8. X-ray tube comprising:
an emitter (31) for emitting electrons,
an anode (32) for receiving emitted electrons, and
a detection unit (40), adapted to detect stray electrons reflected from the anode (32), and adapted to output a signal depending on the detected stray electrons.

9. X-ray tube of claim 8, wherein the detection unit (40) comprises a collector (41) for collecting the stray electrons.

10. X-ray tube of claim 9, wherein the collector (41) is electrically isolated from the x-ray tube (30).

11. X-ray tube of claim 8, wherein a surface of the anode is provided with one or more marks (38, 39) capable of modulating the number of stray electrons detected by the detecting unit (40).

12. X-ray tube of claim 11, wherein the marks (38, 39) are groves (38) and/or pimples (39).

13. Examining device for examining an object to be examined, the examining device comprising:
a device (10) for providing a controlling signal for controlling focal spot parameters of a focal spot on an x-ray tube anode (2), the device (10) comprising:
an interface (11) adapted for receiving a signal having a characteristic pattern depending on stray electrons detected in the x-ray tube (30),
an evaluation unit (15, 16) adapted for evaluating the characteristic pattern, and
an output (18) adapted for outputting a controlling signal based on the evaluation of the characteristic pattern, and
the x-ray tube (30) of claim 8.

14. Method for providing a control signal for controlling focal spot parameters of a focal spot on an x-ray tube anode (32), comprising:
detecting stray electrons reflected from the anode (ST2),
outputting a signal having a characteristic pattern, wherein the signal is based on the detected stray electrons (ST3),
evaluating the characteristic pattern, (ST5) and
generating the controlling signal for controlling focal spot parameters by controlling operating parameters of the x-ray tube (30), wherein the signal is based on the evaluation of the characteristic pattern (ST7).

15. Method of claim 14, further comprising comparing the characteristic pattern with information stored in a look-up table (16) having stored therein at least one relation between the characteristic patterns and the corresponding operating parameters and/or the corresponding focal spot parameters (ST6).

16. Method of claim 15, further comprising generating controlling signals for controlling the focal spot parameters based on information stored in the look-up table (16) and on desired focal spot parameters (ST7A).

17. Program element, which, when being executed by a processor, is adapted to carry out the method of claim 14.

18. Computer readable medium having stored the program element of claim 17.
